(19) United States
(12) Patent Application Publication
(10) Pub. No.: US 2004/0217190 A1
(43) Pub. Date: Nov. 4, 2004

(54) Water irrigation system

(76) Inventor: Anthony Michael Silva, Neptune, NJ (US)

Correspondence Address: Charles I. Brodsky, Esq., 2 Bucks Lane, Marlboro, NJ, 07746, US

(21) Appl. No.: 10/414,535

(22) Filed: Apr. 17, 2003

(51) Int. Cl. A01G 27/00

(52) U.S. Cl. 239/69

(57) ABSTRACT

A water irrigation system operative without a master time clock, and in which the valves employed serve as their own Tees in watering individual zones of a field, for a time interval preselected through cam adjustment, and resettable to their initial pre-set positions by spring actuation in response to a decrease in water pressure below a preselected level.

### CROSS-REFERENCE TO RELATED APPLICATIONS

NONE

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1.Field of the Invention

This invention relates to water irrigation systems, in general, and to such systems as are especially advantageous in the irrigation of large fields, in particular.

2. Description of the Related Art

Automatic water zone sprinkling systems for residential lawns are well known. Similar mistings of produce in retail supermarkets, and misting, fogging and watering of shrubs and trees in greenhouses and garden sales centers are also well known. In a typical installation, a master timing clock controls a series of electrically wired switches to open and close various valves in the water supply chain at various time intervals.

In the irrigation of large fields and golf courses, on the other hand, the cost of the electrical wiring to the outer regions usually is too costly to absorb because of the relatively great distances of travel from the clock to the solenoid switch controlling each zone. When the cost of the complex timing clock for all these zones is additionally factored in, it is not difficult to understand why these large areas employ switches and valves that are generally controlled manually, instead.

### SUMMARY OF THE INVENTION

As will be understood, in such known water control systems, one or more tees are coupled to distribute water simultaneously from the main to each zone to be irrigated by way of individual controllers; only those controllers which are then “on” and “open” pass the water through, even though all water controllers are essentially charged. Then, when the timing clock runs the prescribed period, each controller, in turn, effectively “closes” and shuts “off” until the sequencing begins anew.

As will become clear from the following description, however, the water irrigation system of the present invention prevents any water from the main reaching a succeeding controller until the previous controller in the line has already irrigated its zone its allotted time. As will be seen, the water valve apparatus described operates to direct the water flow to its first intended zone the preset time, after which the valve automatically opens to continue the water flow to the second valve in the line—which operates in like fashion. A “stop” is then placed on the last valve in the irrigation chain, shutting down the system when its timed interval runs.

As will further be seen, a pressure relief valve is inserted between each zone, before each water controller, to detect a drop in water pressure below a preselected level. When this happens, included springs reset each valve simultaneously to their initial quiescent time set conditions. As will be appreciated, this occurs when the water main is shut off—so that a timed turn-off of the main resets the entire system. The time clock utilized, essentially, then serves as its own Tee.

As will be appreciated by those skilled in the art, one advantage of the water irrigation system of the invention is that all that is actually needed to carry it out is a gas powered pump, lengths of polyvinylchloride (PVC) hose, and the valves in question (which all can be manufactured at a reasonably inexpensive cost). A large field, for example, could then be irrigated as many hours in the day as one wants, in as many zones as needed (such as 24 zones, one hour each), to then automatically reset and run all over again. To operate a second system, all that then would be needed would essentially be a second pump, further hose and additional valves. Thus, the water irrigation system offers great advantages in desert areas where running wires out to each valve becomes difficult, or in third world countries of limited funds for investment. Complex time clocks for each valve are not at all required, and an operation is presented which is substantially trouble free to run, easy to repair if need be, and without too many parts able to break down.

### BRIEF DESCRIPTION OF THE DRAWINGS

These and other features of the present invention will be more clearly understood from a consideration of the following description, taken in conjunction with the accompanying drawings, in which:

FIG. 1 is a block diagram helpful in an understanding of a prior art method of water irrigation—whether for residential lawns, greenhouses or small-to-mid-size fields;

FIG. 2 is a block diagram helpful in an understanding of the water irrigation system of the present invention; and

FIGS. 3 and 4 are a pictorial diagrams of water clocking valve operations according to the invention.

### DETAILED DESCRIPTION OF THE INVENTION

As will become clear from the following description, the water irrigation system of the present invention does away with any need for a complex time clock, and any need to run electric wiring to the individual valves which control water flow to the zones to be irrigated. As will also become clear, the water valves that are employed are of a type internally including various gears which rotate as water flows through them a length of time manually set by the user before operation commences. Such water valves are different from those typified by the manufacture of the Gilmour Company of Bucks County, Pa., which conventionally close off the valve once the time has run down. Water valves of this type will be understood by those skilled in the art to have two positions: open (passing the water flow through) and closed (preventing further water flow). With the water valves of the invention, on the other hand, three sets of operations are provided: first, diverting the water flow to the zone to be then irrigated; second, closing off that flow, but opening the valve to distribute the water flow to the next succeeding valve in the chain; and, third, resetting the valve to its initial quiescent condition where the zone watering can begin anew.

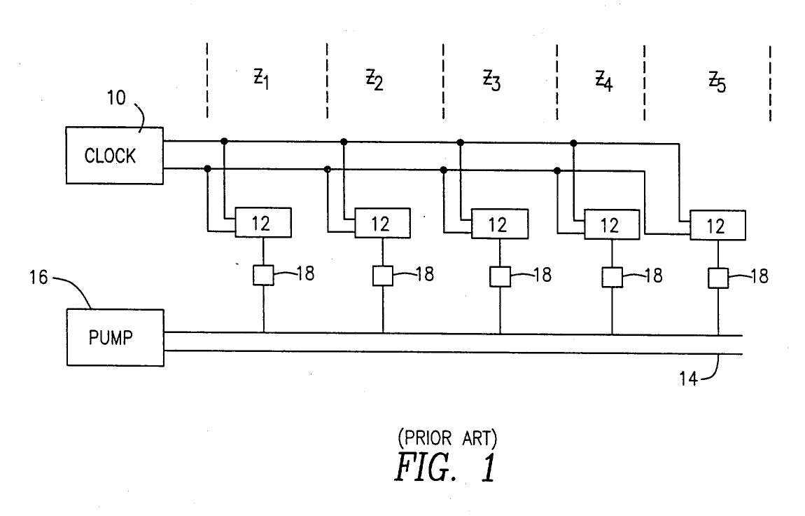

Thus, referring to a prior art type of irrigation system as shown in FIG. 1, a timing clock 10 is connected electrically to open and close individual ones of a plurality of valves 12, conventionally by solenoid control. A water main of PVC hose 14 is charged by a pump 16 in supplying water simultaneously to each of the valves 12 by way of included Tee connectors 18. As individual ones of the valves 12 are opened by the clock 10, various zones Z₁-Z₅ are irrigated in the sequence set by the clock, and for the time intervals preset therein. As will be appreciated, the more zones there are, the more electrical wiring is needed, and the more complex the clock design must be.

With the water irrigation system improvement of the present invention, on the other hand, the same number of valves are employed 30, along with an additional stop valve 32. Before each valve 30 in the chain, a further pressure relief valve 34 is coupled in. The same pump 16 and main 14 are employed, but the clock 10 and its various electrical wiring (shown as 100, 102 in FIG. 1) are eliminated.

As will be understood from the following description, each valve 30 includes a series of internal gears arranged to count down in time according to the manual rotation of a time sequencing knob, or other manner of time preset incorporated within each valve. At the conclusion of the time period, the water flow to a particular zone (such as Z₁) is diverted instead through the valve which opens, to continue the water flow to the next succeeding valve in the chain. Once the preset time in that succeeding valve (such as that feeding zone Z₂ runs), that valve diverts the water flow through and into the next valve in the line. Once the last zone(Z₅) has been irrigated, the diverted water through its valve to the ending stop valve 32 is detected to shut off the flow—which may be sensed at 36 and utilized to control a relief valve 34 in resetting each valve 32 to their initial condition, such that with the pump 16 continuing to run, the irrigation cycle starts over again. Alternatively, the sensor 36 may shut off the water pump 16 which produces the same effect for the relief valve 34 in resetting the individual valves 30. Starting the pump 16 once more likewise begins the irrigation process anew. As will be appreciated, such relief valves are of a type to be pressure responsive, and effectuate the resetting of the valves 30 by a spring-loaded action.

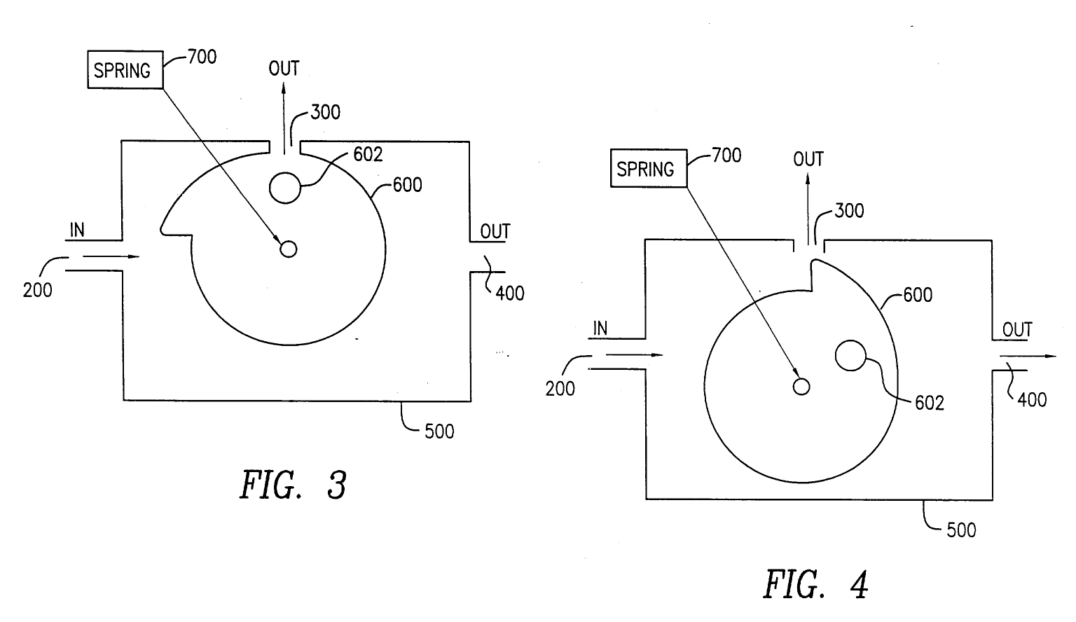

FIGS. 3-4 are helpful in understanding how the water irrigation system of the present invention is switched from one zone to the next by the use of the water powered valves themselves. When the water source is later shut off, the valves all switch back to their primary preset starting points by the use of a spring loaded cam. Totally absent is any electrically provided switching which takes place from one valve to the next. Although the particular construction of the water valve may differ from one design to the next, the basic concept of its operation will be the same, consistent with the showings of FIGS. 3 and 4. In both these illustrates, a single inlet port 200 is shown, with a pair of outlet ports 300, 400; inlet port 200 receives the water flowing in the main, outlet port 300 is used to irrigate the zone in question, and outlet port 400 couples to the inlet port of the next water valve in the chain—except that the last water valve in the line has its outlet port 400 coupled to the “stop valve”. As will be appreciated, each water valve—shown as 500 in FIGS. 3 and 4—employ an internal gearing system which counts down for a time that can be manually preset in accordance with the schedule as to how long each zone is to be irrigated by its respective valve.

FIG. 3 then, for example, illustrates the condition where the valve 500 is operating to irrigate the zone; outlet port 300 is “open” and outlet port 400 is “closed”. Water flowing around a cam 600 flows through an included aperture 602 to exit the port 300. FIG. 4 then illustrates the position after the preselected time has run, thereby “closing off” the outlet port 300, and “opening” the outlet port 400. The water from the main continues to flow around the cam 600 and through its aperture 602, but then exits through the port 400 to the next valve in the chain. This continues from successive valve to successive valve, with all preceding ones in the line being shut “off” and only with the valve irrigating the last zone then discharging water through its outlet port 300. Once that last valve 500 has run its preselected time, the water flow exits its outlet port 400 to the “stop” valve 32, thereby terminating all water flow. In such manner, then, each valve 500 is powered by the water running through it alone, without any electrical or pneumatic actuation. Each valve will be seen to be either delivering water to outlet port 300 or outlet port 400, but never to both at the same time—and, while the system is operating, no valve will ever be “off”.

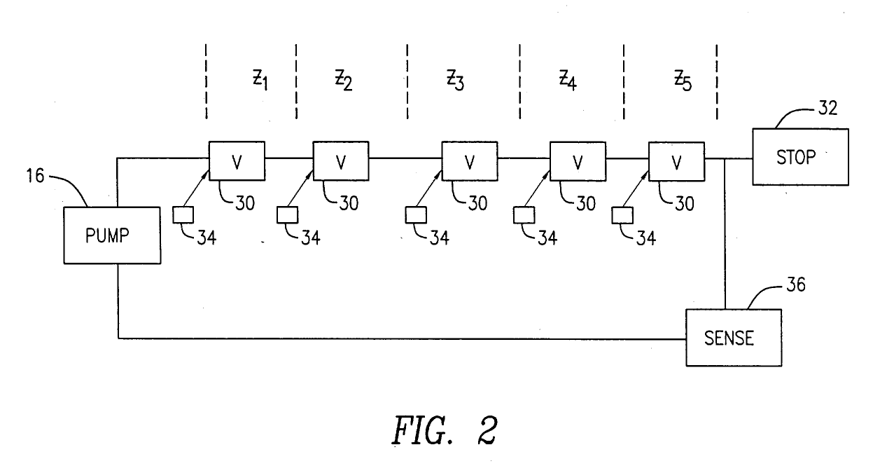

Each cam 600, however, is spring-loaded, as illustrated at 700, to actuate its respective cam back to its initial, quiescent position as to the preselected time it was scheduled to run. A sensor 36 of appropriate design is inserted in the line (as shown in FIG. 2) to sense the drop in pressure, as occurs when the stop valve 32 terminates the water stream. Contemporaneous with this, or effectuated thereafter, the water main pump in a preferred embodiment is switched “off”, with each pressure relief valve sensing the drop below a preset level in resetting each associated valve to await the “turn on” of the pump once more. In this respect, a master solenoid might be incorporated along with the water pump itself, to receive a signal back from the sensor that the entire time period has run. Only one such set of wires would there be required—although the resetting can work just as well by a manual shutting off of the water supply, and a turning of it then back on. The water irrigation system then repeats its operation, with each valve in the line being turned on to irrigate in turn, its preselected period of time, one after the other.

As the valves can be considered as their own “Tees”, all that is required in operation would be the PVC piping hose between each valve, the water valves themselves, the stop valve, and the water pump—along with various crimping accessories to secure everything together. When the pump shuts down, the spring response follows to reset the cam of each valve to align its internal gears for counting down the pre-selected time.

While one drawback of the present invention is its serial alignment of valves such that if one valve became defective, water flow to the next valve in the line might fail. However, that can quickly be observed, visually, or detected by appropriate alarm signals, so that replacement or other repairs could be made. On the other hand, a significant benefit of the system is its usefulness for large field irrigations—where, to expand the system's operation, one need just add additional piping and valves, without having to employ a further complex time clock and its further electrical wirings. All that would be required would be to open to stop the stop valve connected to the outlet port 400 of the last valve, and connect it instead to the added valves—with the stop valve then serving to terminate the extended line.

Analysis has shown that water valves of this type, being spring-resettable with an aperture in the timing mechanism through which the inputted water could flow either through one or another of a pair of outlet ports, could sell for somewhere between $20.00 and $25.00. A 3-zone system employing 100 feet of PVC pipe could then easily be brought in for less than $100.00, without any need for a complex timing clock with its electrical wiring. With the water irrigation system of the invention, all valves employed would run on water pressure, without requiring any electrical wiring to them whatsoever.

While there have been described what are considered to be preferred embodiments of the present invention, it will be readily appreciated by those skilled in the art that modifications can be made without departing from the scope of the teachings herein. Thus, whereas the present invention has been described in the preferred context of resetting each water valve once the water source is shut down, the operation can continue as well where the pressure relief valves reset on drops in pressure below the preselected level, rather than falling to zero. As will also be appreciated, a sprinkler head attachment could be incorporated directly with the water clocking valve of the invention, coupled to its first outlet port 300, to form a one-piece unit operable in the manners described. For at least such reasons, therefore, resort should be had to the claims appended hereto for a true understanding of the scope of the invention.

I claim:

1. A water clocking valve comprising:
an inlet port, a pair of outlet ports, and a rotatable cam driven by gearing means actuated by pressured water applied to said inlet port;
said rotatable cam serially opening to water flow first one of said outlet ports, and then closing said first outlet port and opening the other of said outlet ports a preselected time interval thereafter;
means for manually establishing an initial quiescent position for said rotatable cam;
and spring means coupled with said rotatable cam responsive to sensed water pressure for resetting said rotatable cam to said initial quiescent position when sensed water pressure falls below a preselected level;
and with said inlet port, said pair of outlet ports, said rotatable cam and said gearing means being enclosed within a unitary housing.

2. The water clocking valve of claim 1 wherein said rotatable cam includes an aperture through which pressured water applied to said inlet port flows to said one, and then to said other of said outlet ports in turn.

3. The water clocking valve of claim 2, also including means coupled with said gearing means for establishing said preselected time interval between opening said one, and then said other of said output ports to water flow in turn.

4. The water clocking valve of claim 1 wherein said spring means resets said rotatable cam to said initial quiescent position when said sensed water pressure falls to zero.

5. A water irrigation system comprising:
a first water clocking valve within a first unitary housing including an inlet port, a pair of outlet ports, and a rotatable cam driven by gearing means actuated by pressured water applied to said inlet port; with said rotatable cam serially opening to water flow first one of said outlet ports and then the other of said outlet ports, closing said first outlet port, a preselected time interval thereafter; means for manually establishing an initial quiescent position for said rotatable cam; and spring means coupled with said rotatable cam responsive to sensed water pressure to reset said rotatable cam to said initial quiescent position when sensed water pressure falls below a preselected level;
a second water clocking valve within a second unitary housing including an inlet port, a pair of outlet ports, and a rotatable cam driven by gearing means actuated by pressured water applied to said inlet port; with said rotatable cam serially opening to water flow first one of said outlet ports and then the other of said outlet ports, closing said first outlet port, a preselected time interval thereafter; means for manually establishing an initial quiescent position for said rotatable cam; and spring means coupled with said rotatable cam responsive to sensed water pressure to reset said rotatable cam to said initial quiescent position when sensed water pressure falls below a preselected level;
and with said other of said outlet ports of said first unitary housing being coupled to said inlet port of said second unitary housing.

6. The water irrigation system of claim 5 wherein the rotatable cam of each of said first and second unitary housing includes an aperture through which pressured water applied to their respective inlet ports flows to said one, and then to said other of their respective outlet ports in turn.

7. The water irrigation system of claim 6, also including manual means coupled with said gearing means within each of said first and second unitary housings for establishing said preselected time intervals between opening said one, and then said other of said outlet ports to water flow in said housings, in turn.

8. The water irrigation system of claim 5 wherein said spring means in each of said first and second unitary housings are responsive to sensed water pressure to reset their rotatable cams to their initial quiescent positions when said sensed water pressure falls substantially to zero.

9. The water irrigation system of claim 5 including first and second pressure relief valves coupled to sense water flow to the inlet port of each of said first and second unitary housings, respectively.

10. The water irrigation system of claim 9, also including a stop valve coupled to said other of said output ports of said second unitary housing.
